(19) United States
(12) Patent Application Publication
(10) Pub. No.: US 2006/0224533 A1
(43) Pub. Date: Oct. 5, 2006

(54) Neural network development and data analysis tool

(76) Inventor: Stephen L. Thaler, St. Louis, MO (US)

Correspondence Address: HUSCH & EPPENBERGER, LLC, 190 CARONDELET PLAZA, SUITE 600, ST. LOUIS, MO, 63105-3441, US

(21) Appl. No.: 11/375,630

(22) Filed: Mar. 14, 2006

Related U.S. Application Data
(60) Provisional application No. 60/661,369, filed on Mar. 14, 2005.

(51) Int. Cl. G06N 3/02

(52) U.S. Cl. 706/15

(57) ABSTRACT

A neural network development and data analysis tool provides significantly simplified network development through use of a scripted programming language, such as Extended Markup Language, or a project “wizard.” The system also provides various tools for analysis and use of a trained artificial neural network, including three-dimensional views, skeletonization, and a variety of output module options. The system also provides for the possibility of autonomous evaluation of a network being trained by the system and the determination of optimal network characteristics for a given set of provided data.

### CROSS-REFERENCE TO RELATED APPLICATIONS

This application claims the priority of provisional application Ser. No. 60/661,369, filed Mar. 14, 2005.

### TECHNICAL FIELD OF THE INVENTION

This invention relates generally to the field of artificial neural networks and, more particularly, to a system for developing artificial neural networks and data analysis tool.

### BACKGROUND OF THE INVENTION

A neural network is a collection of ‘switches’ that interconnect themselves to autonomously write computer programs. Rather than supply all of the “if-then-else” logic that typically resides within computer code, only exemplary sets of inputs and desired program outputs are supplied. As a computer algorithm quickly shows these “training exemplars” to the network, all of the interconnections are mathematically “spanked”, so to speak, as a training algorithm corrects those inter-switch links that are impeding the accuracy of the overall neural network model. So, whereas statisticians may painstakingly choose the proper basis functions to model systems, such as lines, polynomials, periodic functions like sines and cosines, or wavelets, the artificial neural network starts with no preconceived notion of how to model the problem. Instead, by virtue of being mathematically forced to arrive at an accurate model, it internally self-organizes so as to produce the most appropriate fitting functions for the problem at hand.

Artificial neural networks are usually trained and implemented algorithmically. These techniques required the skills of a neural network specialist who may spend many hours developing the training and/or implementation software for such algorithms. This fact largely precludes the availability of artificial neural networks to all but a relatively limited group of specialists having sufficient resources to develop these networks. While there are examples of the use of a scripting language, specifically Extended Markup Language, with trained neural networks, no researchers have been able to actually train neural networks using such a programming tool.

Therefore, it would be advantageous to develop a system to “democratize” neural network technology by automated the network development process and increasing the hardware platforms with which artificial neural network technology may be used.

The present invention is directed to overcoming one or more of the problems set forth above.

### SUMMARY OF THE INVENTION

One aspect of the invention generally pertains to a neural-network based data analysis tool that utilizes scripted neural network training to specify neural network architectures, training procedures, and output file formats.

Another aspect of the invention pertains to a neural-network based data analysis tool that utilizes a self-training artificial neural network object or STANNO.

Another aspect of the invention pertains to a neural-network based data analysis tool that provides three-dimensional neural network visualization within virtual reality, allowing the user to either view the neural network as a whole, or zoom from any angle to examine the internal details of both neurons and their interconnections.

Another aspect of the invention pertains to a neural-network based data analysis tool that provides the ability to isolate individual model outputs and through a series of simple mouse clicks, reveal the critical input factors and schema influencing that output.

Another aspect of the invention pertains to a neural-network based data analysis tool that provides the ability to generate artificial neural networks in spreadsheet format in which neurons are knitted together through relative references and resident spreadsheet functions.

Another aspect of the invention pertains to a neural-network based data analysis tool that provides optimization of neural network architectures using a target-seeking algorithm, wherein a ‘master’ neural network model is quickly generated to predict accuracy based upon architectures and learning parameters.

In accordance with the above aspects of the invention, there is provided a neural network trainer including a user-determined set of scripted training instructions and parameters for training an untrained artificial neural network, in which the set of scripted training instructions and parameters specified by a scripting language.

In accordance with another aspect, there is provided an artificial neural network-based data analysis system that includes an artificial neural network having a first layer and at least one subsequent layer, each of the layers having at least one neuron and each neuron in any of the layers being connected with at least one neuron in any subsequent layer, with each connection having a weight value; and a three-dimensional representation of the artificial neural network.

In accordance with another aspect, there is provided a neural network trainer that includes an artificial neural network having a first layer and at least one subsequent layer, each layer further having at least one neuron; and means for isolating each of the first layer neurons and modifying an input value to those first layer neuron directly to observe associated changes at the subsequent layers.

In accordance with yet another aspect of the invention, there is provided a neural network trainer that includes an artificial neural network; a set of training instructions and parameters for training the artificial neural network; and a program function that converts the trained artificial neural network into a spreadsheet format.

In accordance with another aspect, there is provided an artificial neural network-based data analysis system that includes a system algorithm that constructs a proposed, untrained, artificial neural network; at least one training file having at least one pair of a training input pattern and a corresponding training output pattern and a representation of the training file; and wherein construction and training of the untrained artificial neural network is initiated by selecting said representation of said training file.

In accordance with another aspect, there is provided a neural network trainer that includes at least a first pair of a training input pattern and a corresponding training output pattern; a first, untrained, artificial neural network; a second, auto-associative artificial neural network that produces a delta value and calculates a learning rate associated with the first artificial neural network; and wherein the delta value represents a novelty metric.

In accordance with yet another aspect, there is provided an artificial neural network-based data analysis system that includes at least a first pair of a training input and a corresponding training output; a first, untrained, artificial neural network that produces at least one output when at least one input is supplied to the first artificial neural network; and a comparator portion that compares an actual output pattern generated by the first artificial neural network as result of said training input pattern being supplied to the first artificial neural network with the corresponding training output, produces an output error based on that comparison, and determines a learning rate and a momentum associated with the first artificial neural network; and wherein the learning rate and momentum for the first artificial neural network are adjusted in proportion to the output error.

In accordance with another aspect of the invention, there is provided an artificial neural network-based data analysis system including at least a first pair of a training input pattern and a corresponding training output pattern; a first, untrained, artificial neural network; and a first algorithm that generates an architecture, learning rate, and a momentum for the first artificial neural network randomly or systematically; at least a second, untrained artificial neural network that trains approximately simultaneously with or sequentially after the first artificial neural network; a second architecture, learning rate, and second momentum associated with the second artificial neural network which is generated randomly or systematically by the first algorithm; a comparator algorithm that compares an actual output pattern generated by either of the networks as a result of the training input pattern being supplied to either network with the corresponding training output pattern and produces an output error based on a calculation of a cumulative learning error; a third artificial neural network that receives and trains on the architectures, learning rates, momentums, and learning errors associated with the first and second artificial neural networks; and means for varying inputs to the third artificial neural network to observe associated outputs of the third artificial neural network to identify an optimal network architecture and an optimal set of learning parameters.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made to the drawings which illustrate the best known mode of carrying out the invention and wherein the same reference numerals indicate the same or similar parts throughout the several views.

FIG. 1 is a screen shot of the working window of an embodiment of a neural network development and data analysis tool according to one embodiment of the present invention.

FIG. 2 is a screen shot of a “tree view” in the embodiment of FIG. 1.

FIG. 3 is a screen shot of a “network view” in the embodiment of FIG. 1.

FIG. 4 is a screen shot of a “manual view” in the embodiment of FIG. 1.

FIG. 5 is a screen shot of a “network view” in another embodiment.

FIG. 6 is another screen shot of the “network view” of FIG. 5 showing only one output neuron's weights.

FIG. 7 is another screen shot of the “network view” of FIG. 5 showing the second layer of a network “skeletonized.”

FIG. 8 is another screen shot of the “network view” of FIG. 5 showing four weights displayed.

FIG. 9 is a “skeletonized” view of the network shown in FIGS. 5-8.

FIG. 10 is a diagram of the general operation of another embodiment in which a first, hetero-associative, artificial neural network and a second, auto-associative, artificial neural network train together.

FIG. 11 is a diagram of the embodiment of FIG. 10 operating in an alternate mode.

FIG. 12 is a diagram of a target-seeking embodiment of the present invention including a series of training networks and a master network.

### DETAILED DESCRIPTION

In the following detailed description, numerous specific details are set forth in order to provide a thorough understanding of the invention. However, it will be understood by those skilled in the art that the present invention may be practiced without these specific details. For example, well-known methods, procedures, and components have not been described in detail so as not to obscure the present invention.

Hereafter, when the term neural network is used, it will refer to a specific paradigm called the multilayer perceptron (MLP), the workhorse of neural networks and the basis of this product. The MLP is a neural network having three or more layers of switches or neurons. Each neuron within any given layer has connections to every neuron within a subsequent layer. Such connections, that are tantamount to the weighting coefficients in traditional regression fits, are iteratively adjusted through the action of the training algorithm until the model achieves the desired level of accuracy

One embodiment of the present invention is a script-based neural network trainer that may be used by a novice, as well as an experienced neural network practitioner. The user sets up a training session using an Extended Markup Language (XML) script that may later serve as a pedigree for the trained neural network. The system provides a permanent record of all the design choices and training parameters made in developing the neural network model. Furthermore, if any difficulties with training are encountered, the XML script, and not necessarily the user's proprietary data, can be analyzed by third party technical support personnel for diagnosis.

The system also solves most of the visualization problems that accompany the training of large neural network models having thousands to millions of inputs and outputs by generating a 3-dimensional, virtual reality model of the network. To survey the network in its entirety, the user “flies” through the network using mouse and/or keyboard commands. By setting a series of bookmarks, the operator may quickly return to key points within the neural architecture. Further, simple mouse actions are used to strip away less significant connection weights to reveal critical input factors and schema (i.e., the underlying logic) within the net.

The system also allows the user to interrogate the network model even in the midst of training. Using a view that displays a series of slider controls corresponding to each model input, one may manually adjust each slider and directly observe the effect upon each of the network's outputs. Using this technique, one may search for certain sweet spots within the model, or carry out sensitivity analysis.

A user has the option of batch file processing of the trained neural network or exporting their trained neural network to a wide range of formats and computer languages that include, C, C++, VisualBasic®, VBA, ASP, Java, Javascript, Fortran77, and Fortran90, and MatLab M-files, MatLab S-files, other MatLab formats, and specialized languages for parallel hardware and embedded targets.

The system also features an Excel export option that functionally connects spreadsheet cells so as to create working neural networks within Excel worksheets. System can also generate parallelized C-code that is compatible with ClearSpeed's newest generation of parallel-processing boards. Alternately, users may now export their neural networks to Starbridge Systems Viva®, a design environment for field programmable gate arrays (FPGA).

The system uses neural networks to find the relationships among various inputs and outputs. These inputs and outputs are any quantities or qualities that can be expressed numerically. For example, a network could find the relationship between the components used to make a material and the material's resulting properties. Or, a neural network could find the relationship between financial distributions and the resulting profits. The neural network learns the same way a person does—by example. Sets of inputs with known outputs are presented to the network. Each set of inputs and outputs is called an exemplar. Given enough exemplars, the network can learn the relationship, and predict the outputs for other input sets.

The system utilizes a “Self-Training Artificial Neural Network Object” or “STANNO.” The STANNO is a highly efficient, object-oriented neural network. The STANNO is also described in U.S. Pat. No. 6,014,653, the disclosure of which is expressly incorporated by reference herein.

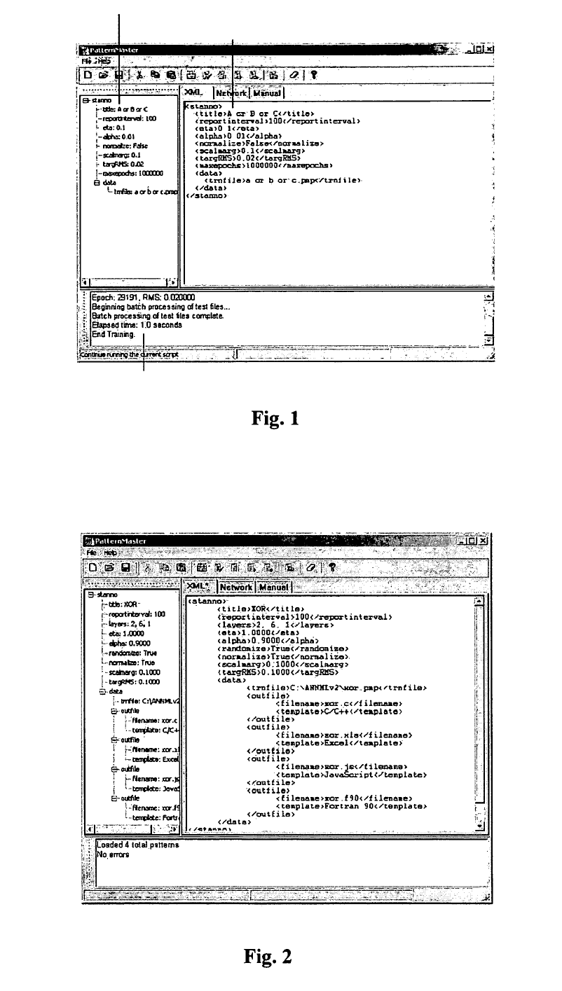

Screen shots from a preferred embodiment of the system are provided in FIGS. 1 though 9. FIG. 1 includes the primary Workspace area. The tabs at the top of the Workspace area labeled “XML” “Network”, and “Manual” are different views of the network. The XML view is the one shown in the figure. This view is the raw XML code containing the parameters of the network. The Tree window shows a simplified, compact view of the information available in the XML view in the Workspace. Data and parameters can be modified in this window as well as in the Workspace XML view. Changes to one will immediately show up in the other. The Status window shows the current Status of the system. It displays what the program is doing, shows how far any training has progressed, any errors that have been encountered, and more. It is important to check this window often for information regarding the project. These windows can be undocked and moved away from the main application window. To do this, click on the docking grip and drag it to the desired location.

Project files are stored in standard XML format. Below are each possible tag and a brief description of what it is used for.

<Stanno>—This is the parent tag for each stanno, or neural network. All networks must exist inside a stanno tag.

<Title>—The title of the network. This is sometimes used within output code modules as the name of the class or module.

Example: <title>My Network</title>

<ReportInterval>—During training, this specifies how often (in epochs) to report the current RMS error of the network. In no instance will the report be printed more than twice every second. (Default: 100)

Example: <reportinterval>5000</reportinterval>

<WorkDir>—Using WorkDir, you can specify a separate folder for holding the training and testing data for the network. (Default: blank)

Example: <workdir>C:\Projects</workdir>

<DestDir>—Using DestDir, you can specify a separate folder for where the output code modules will be saved. (Default: blank)

Example: <destdir>C:\Projects</destdir>

<Layers>—This specifies the number of layers as well as the number of nodes for each layer. The example below puts together a 3 input, 2 output network. If Layers does not exist, ANNML will attempt to determine the architecture from the input training data. If it can determine the number of inputs and outputs from the training data, it will default to a 3 layer network with the hidden layer containing 2n+2 nodes where n equals the number of inputs. Most networks only require 3 layers. If more layers are required for a particular data set, 4 will usually be sufficient. More layers will make training more accurate, but will hurt the network's ability to generalize outside of training. Additional layers will also make training slower. You can have up to 6 layers in an ANNML network.

Example: <layers>3, 8, 2<\layers>

<Seek>—This is the parent tag for Automatic Architecture seeking. If this tag exists, the system will attempt to find the optimal network architecture for the current project. Note: After finding an optimal architecture, it is necessary to change the number of hidden layer nodes in the <Layers> tag to match the new architecture. Otherwise, loading any saved weights from the optimized set will result in an error due to the saved data in the weights file not matching the XML description of the network. Also, after training an optimized network, it may be desirable to remove this tag and its children from the ANNML project, as any further training of the network with this tag block present will result in another search for an optimal architecture.

<Attempts>—A child of Seek, this specifies the number of different architectures to try before deciding on a winning architecture.

Example: <attempts>20</attempts>

<Subset>—A child of Seek, this specifies the percentage of the original input data to reserve for the generalization phase of the optimal architecture seek.

Example: <subset>10</subset>

<MaxNodes>—A child of Seek, this specifies the maximum number of nodes possible for any given layer in the network during the seek phase.

Example: <maxnodes>100</maxnodes>

<MinNodes>—A child of Seek, this specifies the minimum number of nodes possible for any given layer in the network during the seek phase.

Example: <minnodes>20</minnodes>

<Eta>—This parameter can control the amount of error to apply to the weights of the network. Values close to or above one may make the network learn faster but if there is a large variability in the input data, the network may not learn very well, or at all. (Default: 1.0)

Example: <eta>0.1</eta>

<Alpha>—This parameter controls how the amount of error in a network carries forward through successive cycles of training. A higher value will carry a larger portion of previous amounts of error forward through training so that the network avoids getting “stuck” and stops learning. This can improve the learning rate in some situations by helping to smooth out unusual conditions in the training set. (Default: 0.1)

Example: <alpha>0.5</alpha>

<Normalize>—When enabled, this will normalize the inputs before being sent to the network. This helps to spread the input data across the entire input space of the network. When data points are too close together, the network may net learn as well than if the network is spread to encompass the entire range between the minimum and maximum points. (Default: True)

Example: <normalize>true</normalize>

<ScalMarg>—This provides a means to scale the inputs and outputs to a particular range during normalization. In certain instances, the network can not achieve a good learning rate if the input values are too close together or are too close to zero and one. The Scale Margin will normalize the data between the minimum and maximum values and add or subtract half of this value to the input value. (Default: 0.1)

Example: <scalmarg>0.1</scalmarg>

<Randomize>—This specifies whether to randomize the training sets during training, or to train on them sequentially as they exist in the training set file. Randomized training sometimes helps to avoid ‘localized learning.’ (Default: False)

Example: <randomize>true</randomize>

<Noise>—This specifies how much noise to add to each input value. The format is of two floating point numbers separated by a comma. The first number represents the lower bound of the noise range. The second number represents the upper bound. The example below would add a random number between −0.01 and +0.01 to each input value during training. Alternately, if only one number is present in the noise tag, the positive and negative values of that number will be used as the upper and lower bounds instead. (Default: 0.0, 0.0)

Example: <noise>−0.01, 0.01</noise>

<TargRMS>—This specifies the target RMS for the network to train down to. Once the error from the network drops below this RMS, training will stop and output modules will be generated. This can be set to zero to disable target RMS seeking. In this case, MaxEpochs must be set to a non-zero value. (Default: 0.03)

Example: <targrms>0.05</targrms>

<MaxEpochs>—This specifies the maximum number of epochs for the network to train on. Once the network has trained on the maximum number of epochs, training will stop. This can be set to zero to allow unlimited epochs. In this case, TargRMS must be set to a non-zero value. (Default: 0) Note: The MaxEpochs tag can also be used as a child of the Seek tag, and will take precedence over any external MaxEpochs tags for the purposes of finding an optimal architecture.

Example: <maxepochs>500000</maxepochs>

<TestInt>—This specifies the interval at which to test the network with a given set of test data. (Default: 100)

Example: <testint>50</testint>

<Data>—This is the parent tag for the data set in each stanno object.

<TrnFile>—A child of Data, this specifies the filename of the input training set. This can either be a full pathname to the file, or a path relative to either the folder that the ANNML project exists, or the folder where the system application was launched from. The format of this file is described in the section on Inputs below.

Example: <trnfile>traindata.pmp</trnfile>

<LabelFile>—A child of Data, this specifies the filename of the input labels. This can either be a full pathname to the file, or a path relative to either the folder that the ANNML project exists, or the folder where the system application was launched from. The format of this file is a single line of text with each label separated by a tab and two tabs separating the last input label and the first output label. This file should only be used if the input training set does not contain labels of its own. (Default: blank)

Example: <labelfile>labels.txt</labelfile>

<Labels>—A child of Data, this specifies a line of text to be used as input and output labels. The format of this text is a single line of text with each label separated by a comma and two commas separating the last input label and the first output label. This tag should only be used if the input\training set does not contain labels of its own. (Default: blank)

Example: <labels>in1, in2,, out1</labels>

<WtFile>—A child of Data, this specifies the filename of the network weights file. This can either be a full pathname to the file, or a path relative to either the folder that the ANNML project exists, or the folder where the system application was launched from. This file is used to load and save the weights of the network. (Default: blank)

Example: <wtfile>insects.wts</wtfile>

<LoadWts>—A child of Data, this specifies the filename of the network weights file. This can either be a full pathname to the file, or a path relative to either the folder that the ANNML project exists, or the folder where the system application was launched from. This file is only used to load the weights of the network. This tag, along with SaveWts is used to specify a different file name for loading versus saving. (Default: blank)

Example: <loadwts>insects.wts<loadwts>

<SaveWts>—A child of Data, this specifies the filename of the network weights file. This can either be a full pathname to the file, or a path relative to either the folder that the ANNML project exists, or the folder where the system application was launched from. This file is only used to save the weights of the network. This tag, along with SaveWts is used to specify a different file name for loading versus saving. (Default: blank)

Example: <savewts>insects.wts</savewts>

<DFile>—A child of Data, this specifies the filename of the summary. This file will be written when training stops and will contain a short summary of the network architecture and the number of epochs and amount of error when training stopped. (Default: blank)

Example: <dfile>summary.txt</dfile>

<RMSFile>—A child of Data, this specifies the filename of the RMS error log. This file will be written during training and will contain one line of text representing the error of the network. This file is useful for graphing the error over time as the network trained. (Default: blank)

Example: <rmsfile>errorlog.txt</rmsfile>

<OutFile>—A child of Data, this is the parent tag for each output code module. If no OutFile tags exist, then no code modules will be generated.

<Filename>—A child of OutFile, this specifies the filename of the output that will be generated, relative to the DestDir tag.

Example: <filename>excelout.xls</filename>

<Template>—Also a child of OutFile, this specifies the template to use for generating the file. There are several different built-in templates:

C/C++
ClearSpeed ™
Fortran 77
Fortran 90
Java ™
JavaScript ™
Visual Basic ™
Viva
Excel ™
MATLAB ® M-file
MATLAB ® S-file

Specify one of the above template names for this tag to use that built-in template.

Example: <template>Excel</template>

You can also generate a module using a custom template. Simply specify the filename of the template instead. A description of the template file is provided in the section on Output Code Modules for the new Project Wizard below.

<TestFile>—A child of Data, this is the parent tag for each training set to test the network with after training is complete.

<SourceName>—A child of TestFile, this specifies the filename of the training set data. This can be either raw tab-delimited data or a .pmp file.

Example: <sourcename>testdata.pmp</sourcename>

<TargetName>—A child of TestFile, this specifies the filename of the output file that will be generated, relative to the DestDir tag.

Example: <targetname>test-out.txt</targetname>

<ScaleInputs>—A child of TestFile, this specifies whether to scale, or normalize the inputs to between zero and one before testing them. (Default: True)

Example: <scaleinputs>false</scaleinputs>

<LeaveInputsScaled>—A child of TestFile, this specifies whether to write the scaled inputs to the output file, or to write the original input values. (Default: False)

Example: <leaveinputsscaled>false</leaveinputsscaled>

<ScaleOutputs>—A child of TestFile, this specifies whether to scale, or normalize the outputs to the original range of the inputs after testing. (Default: True)

Example: <scaleoutputs>false</scaleoutputs>

<ScaleMargin>—A child of TestFile, this value has the same effect on the training set inputs and outputs as the network's Scale Margin does on training. (Default: The Scale Margin used to train the network)

Example: <scalemargin>0.1</scalemargin>

<MinMax>—A child of TestFile, this overrides the detected minimum and maximum values of the training set when scaling is used. (Default: 0, 0)

Example: <minmax>0, 1</minmax>

The system features a project wizard that walks the user through the creation of a network by stepping through the key network parameters and prompting the user for an appropriate answer for each parameter. These parameters include: the number of inputs, number of outputs, number of layers, whether the network will use a static network architecture that the user defines or whether the system will automatically try to find the optimal network architecture using an underlying algorithm, the number of nodes in each hidden layer, the learning parameters (eta and alpha), learning targets (Max Epochs and Target RMS), the input training file, and output code modules.

The algorithm within the system will independently develop an appropriate network architecture based on the information that is supplied by the user.

In another embodiment, the system algorithm will generate a best guess for an appropriate network architecture based on a selected training data file. When a recognized training data file is selected, the algorithm supplies the number of hidden layers, the number of nodes or neurons within the hidden layers, the learning rate (η) and momentum (α) for the network and then initializes the network prior to training. This particular embodiment is advantageously suitable for neural network novices.

When seeking for the optimal network architecture, the system can use some original training exemplars to determine the lowest generalization error:

Subset—You must specify a valid percentage between 0 and 99. This amount will be removed during the training and used for generalization. A random selection of patterns will be chosen. If zero is entered, then optimization will be based upon training error instead of generalization error and will require a MaxEpochs tag instead of a TargetRMS tag in the Learning Targets section. Note: If your set of training data is small, reserving a subset can cause training to be inaccurate. For example, if the user is training an Exclusive Or network, the training data will consist of the following:

| In1 | In2 | Out1 |
|---|---|---|
| 0 | 0 | 0 |
| 1 | 0 | 1 |
| 0 | 1 | 1 |
| 1 | 1 | 0 |

If the 4th exemplar is reserved, then the network will learn “Or” behavior, not Exclusive-Or.
Number of Attempts—This specifies the number of different architectures to train. Random architectures are chosen and trained while a separate neural network watches the results. Once all attempts are completed, the separate network will be used to generate an optimal architecture.

The Learning Parameters for the network, include:

Eta (η)—This parameter can control the amount of error to apply to the weights of the network. Values close to or above one may make the network learn faster but if there is a large variability in the input data, the network may not learn very well, or at all. It is better to set this parameter to something closer to zero and edge it upwards if the learning rate seems too slow.

Alpha (α)—This parameter controls how the amount of error in a network carries forward through successive cycles of training. A higher value will carry a larger portion of previous amounts of error forward through training so that the network avoids getting “stuck” and stops learning. This can improve the learning rate in some situations by helping to smooth out unusual conditions in the training set.

The Learning Targets specify what events trigger the network to stop training. Both of these parameters may be set to a non-zero value, but at least one must be non-zero to provide a stopping point for the network.
Max Epochs—Specifies the maximum number of epochs for the network. An epoch is one pass through the complete training set.
Target RMS—Specifies the maximum amount of error from the network. Training will continue while the RMS error of each epoch is above this amount. This option will be disabled if Optimal Architecture seeking is enabled and learning error is being used instead of generalization error.

The format of the input file is a tab-delimited text file. A double tab is used to separate the input data from the target output data. Each training set must be on its own line. Blank lines are not allowed. Labels for the input must exist on the first line of the file and are tab-delimited in the same manner as the input training data. As an example, a network with two inputs and one output would have training data in the following format:

In1<tab>In2<tab><tab>Out
0<tab>1<tab><tab>1

The extension for the input training data must be “.pmp.”
Randomize—When enabled, this will randomize the patterns from the training data during training of the network. This helps to reduce ‘localized learning’ which causes the network to become stale in its learning process.
Normalize—When enabled, this will normalize the inputs before being sent to the network. This helps to spread the input data across the entire input space of the network. When data points are too close together, the network may not learn as well as when the inputs are spread to encompass the entire range between the minimum and maximum points.
Scale Margin—This provides a means to scale the inputs and outputs to a particular range during normalization. In certain instances, the network can not achieve a good learning rate if the input values are too close together or are too close to zero and one. The Scale Margin will normalize the data between the minimum and maximum values and add or subtract half of this value to the input value. This value is only used when the Normalize flag is enabled. Scale Margin has the reverse effect on outputs, expanding them back to their original range. Example: With inputs ranging between 0 and 1, and a Scale Margin of 0.1, the inputs will be compressed into the range of 0.05 and 0.95.
Add Noise—Enabling this option will add a random amount of noise to each input value while training. The range is specified in the upper and lower bound area. The upper and lower bound represent the amount of noise that can be added to the input. In most cases, the lower bound equals the negative of the upper bound. If an input value falls outside of the range of 0.0 to 1.0 as a result of adding noise, then it will be clipped to either 0.0 or 1.0.

Output Code Modules can be generated once the network is trained. Multiple output files can be specified. There are a variety of different code templates: C/C++, ClearSpeed™, Fortran 77, Fortran 90, Java™, JavaScript™, MATLAB® M-files, Excel, and Microsoft® Visual Basic®. A custom template format can also be specified. Custom templates are text files that use a text-replacement algorithm to fill in variables within the template. The following variables can be used in a custom format:

%DATE%—The date/time of when the module is generated.

%NUMINPUTS%—The number of inputs for the network.

%NUMOUTPUTS%—The number of outputs for the network.

%NUMLAYERS%—The number of total layers for the network.

%NUMWEIGHTS%—The total number of weights within the network.

%MAXNODES%—The maximum number of nodes at any given layer of the network.

%NODES%—A comma-separated list of the sizes of each layer of the network.

%DSCALMARG%—The scaling margin used to train the network.

%IMIN%—A comma-separated list of the minimum values in the inputs.

%IMAX%—A comma-separated list of the maximum values in the inputs.

%OMIN%—A comma-separated list of the minimum values in the outputs.

%OMAX%—A comma-separated list of the maximum values in the outputs.

%WEIGHTS%—A comma-separated list of all of the internal weights in the network.

%TITLE%—The title of the network.

%TITLE_%—The title of the network with any spaces converted to the ‘_’ character.

The IMIN, IMAX, OMIN, OMAX and WEIGHTS variables act in a special manner. Because they are arrays of numbers, the output method needs to handle a large number of values. Because of this, whenever any of these variables are encountered in the template, the contents of the line surrounding these variables are generated for each line that the variable itself generates. For example, the following line in the template:

%WEIGHTS%_{—}

would generate code that looks like:

0.000000, 0.45696785, 1.000000, _{—}
0.100000, 0.55342344, 0.999000, _{—}

Notice the leading spaces and the trailing space and underscore character. Some languages, such as Visual Basic in this example, use a trailing character to indicate a continuation of the line.

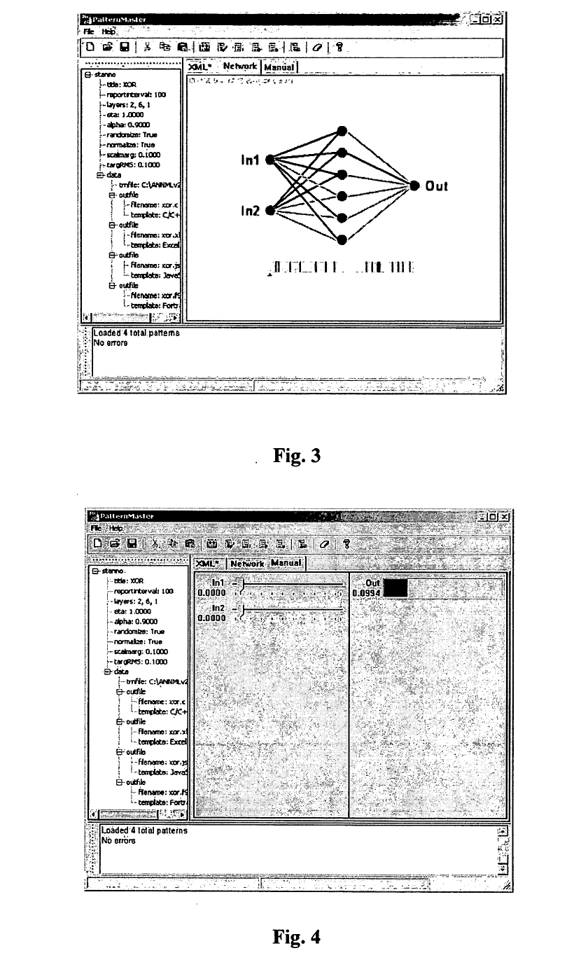

The system has several views to help facilitate the creation and visualization of a neural network. While creating a project, the Tree view and the XML view shown in FIGS. 1 and 2 allow the user to enter and edit the data for the project. During or after training, the user can view the current state of the network by switching to the Network view, an example of which is illustrated in FIG. 3. This is a 3D view of the neural network with its inputs, outputs and current weights represented by 3D objects. The distribution of the weights within the network is also represented below the network. A further description of the Network View is provided below. During or after training, the user can test the network by manually adjusting the inputs for the network in the Manual view, which is shown in FIG. 4. By adjusting each slider that represents an input to the network, you can see how it affects the outputs of the network.

The Network View renders the current project into a 3D space, representing the inputs, outputs, current weights and the weight distribution of the network. This view allows the user to navigate around the network's three dimensions, and also allows the user to isolate outputs and hidden layer neurons to see which inputs have the largest influence on each output. Neurons are represented as green spheres, and weights are represented by blue and red lines. A blue line indicates that the weight has a positive value, while a red line indicated that the weight has a negative value. Left-clicking on a neuron will hide all weights that aren't connected to that neuron, but are on the same layer. The Weight Distribution Bar shows the distribution of weights in the network, ignoring their signs. The far left corresponds to the smallest weight in the network, the far right corresponds to the highest. The presence of a weight or multiple weights is indicated by a vertical green stripe. The brighter the stripe, the more weights share that value.

The Draw Threshold slider is represented as the white cone below the distribution bar. Only weights whose values fall to the right of the slider will be drawn. So at the far left, all weights will be displayed, and at the far right, only the strongest weight will be shown. The slider is useful when we wish to skeletonize the network (see the example below.) The slider can be moved by the mouse. Clicking and dragging the mouse over the weight distribution bar will adjust the draw threshold.

Consider the following three input, two output network. The first output performs the logical operation A or (B and C), which means that the output is high if A is high, or if both B and C are high. The second is high if A, B, or C (or any combination) are high.

| A | B | C | A or (B and C) | A or B or C |
|---|---|---|---|---|
| 0 | 0 | 0 | 0 | 0 |
| 0 | 0 | 1 | 0 | 1 |
| 0 | 1 | 0 | 0 | 1 |
| 0 | 1 | 1 | 1 | 1 |
| 1 | 0 | 0 | 1 | 1 |
| 1 | 0 | 1 | 1 | 1 |
| 1 | 1 | 0 | 1 | 1 |
| 1 | 1 | 1 | 1 | 1 |

After the network has been trained, the Network View can be used to examine how the network has organized itself. What kind of characteristics will the network display? To understand the answer to this question, one must understand how a single neuron works. Each neuron has some number of inputs, each of which has an associated weight. Each input is multiplied by its weight, and these values are summed up for all input/weight pairs. The sum of those values determines the output value of the neuron, which can, in turn, be used as the input to another neuron. So, in the example network, the first output, labeled A or (B and C), will produce a high output value if just A is high, but if A is low, it would take both B and C to create a high output. This should mean that the weight value associated with A will be the highest. We can use the network view to verify this. The process of tracing back from the outputs to the inputs in order to find out which inputs are most influential is called skeletonization, and we will use the above example to demonstrate.

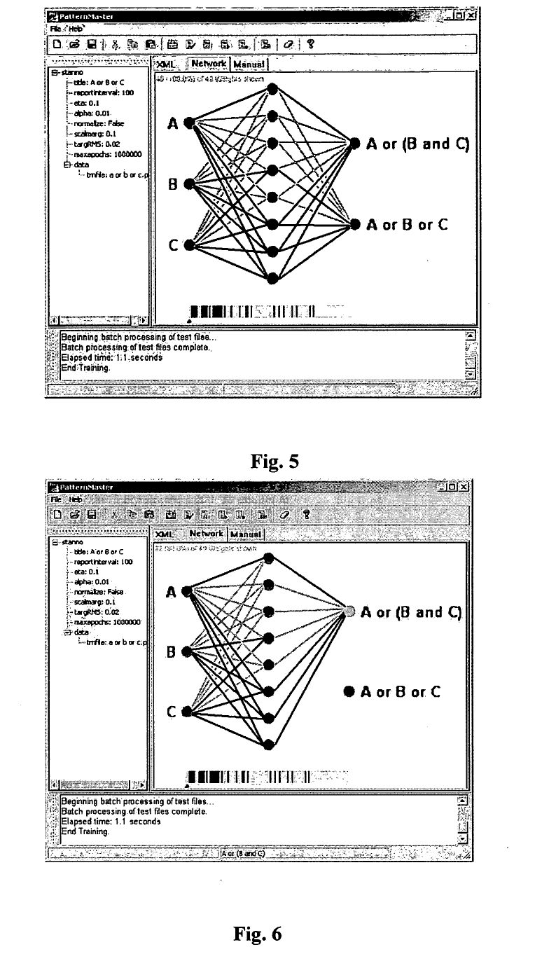

A sample Network View is provided in FIG. 5. All of the weights are displayed. It the user is interested in verifying the strongest influence on the output A or (B and C), left-click the mouse on that output. The result is shown in FIG. 6. Left-clicking on that neuron will cause the other output's weights to be hidden. In addition, any adjustments made to the weight threshold slider will only affect the neuron that we selected.

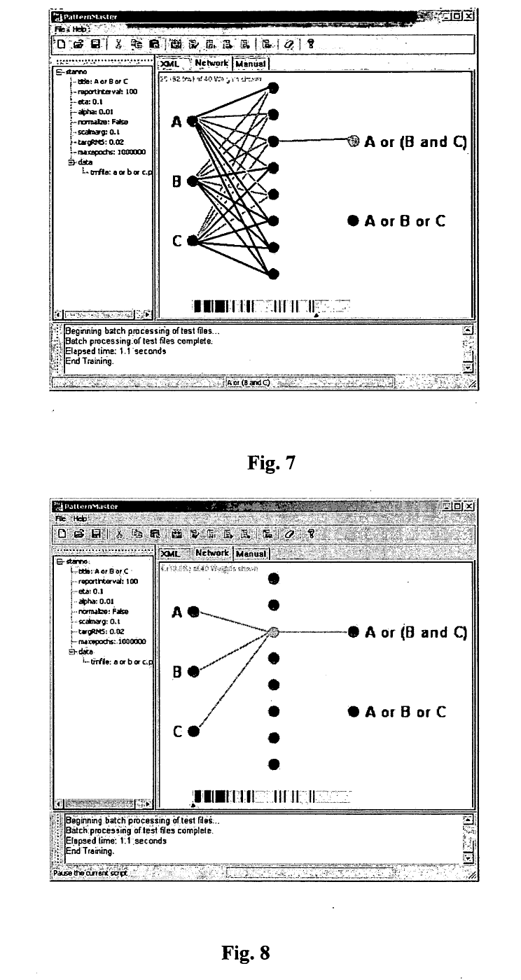

Next, move the slider to the right until only one of the weights connected to A or (B and C) are being shown. The result is illustrated in FIG. 7. Now only the weight with the highest magnitude is being drawn. In the illustrated example, it is connected to the third node down from the top in the hidden layer, but this will vary from network to network. Note that the position of the draw threshold slider indicates only affects the second set of weights, those to the right of the hidden layer. This is because a neuron to the right of the hidden layer was selected.

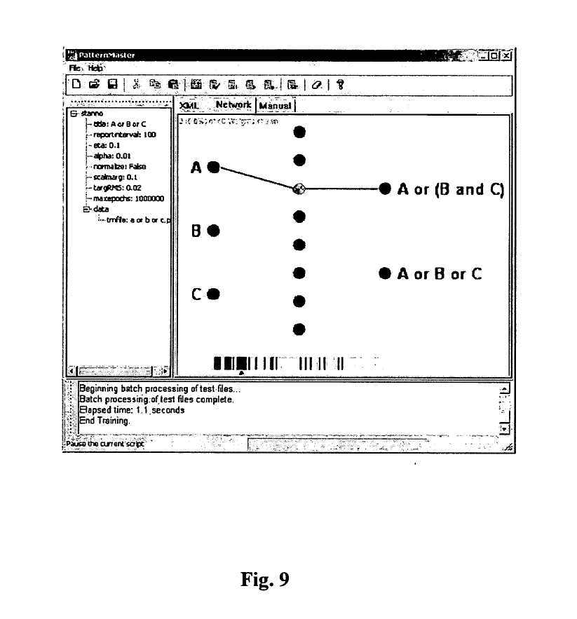

Now, if the user left-clicks on the hidden layer node whose connection to the output is still visible, this will cause only the weights going into it to be drawn. The result is illustrated in FIG. 8. Note that the draw threshold slider has been automatically reset to the far left, since a new layer has been selected. If the slider is moved to the right until only one weight is being shown going into the hidden layer, the result is shown in FIG. 9. And, as expected, the input with the most influence on the output A or (B and C) is A. Note that both weights are positive. Since two positive numbers multiplied together yield a positive number, this is the same as both weights being negative. In both cases, a positive change in A will cause a positive change in A or (B and C). If only one of the two weights was negative, a negative change in A would have caused a positive change in the output. This can be seen when a network is trained to implement NOT(A) or (B and C). To return the network to normal or to skeletonize another output, double-click anywhere in the 3D view.

In one embodiment of the system, a user can initiate training of network by simply selecting a specific training data file. The native algorithm within the system will automatically recommend a best guess as to appropriate architecture for the network, i.e., number of the hidden layers needed and the number of neurons within each hidden layer, as well as learning rate and momentum for the network, and then initializes this untrained network.

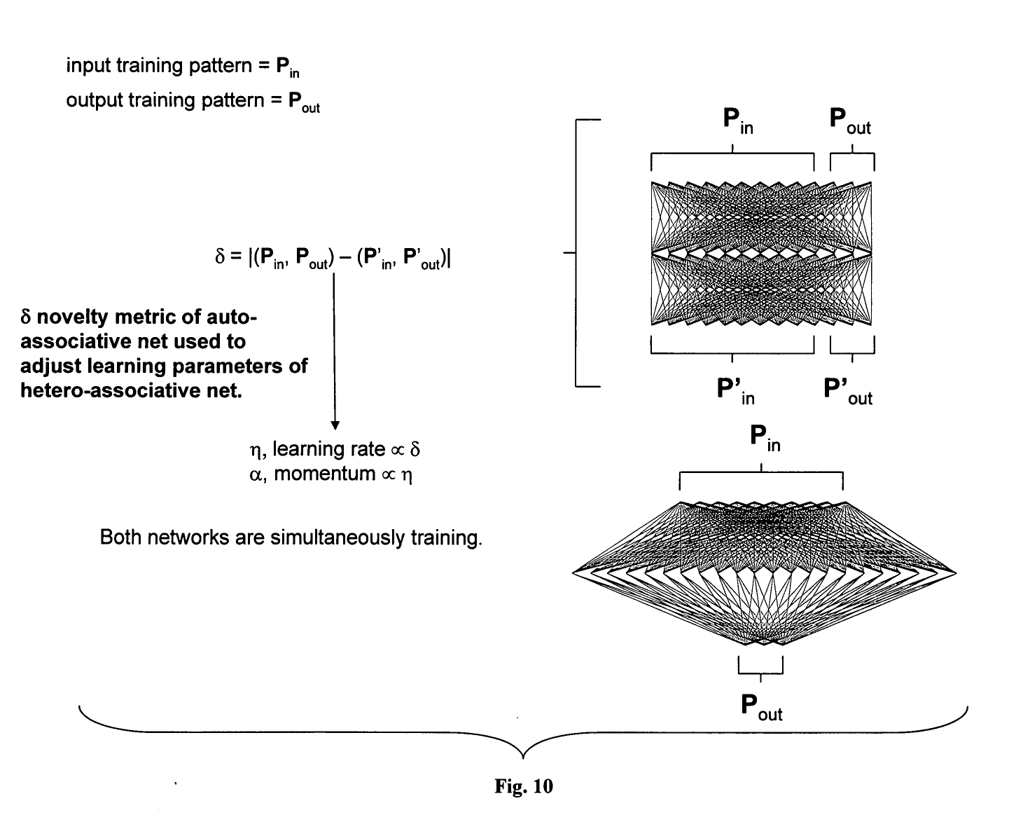

In another embodiment, the system utilizes a second artificial neural network, advantageously an auto-associative network, which may train simultaneously with the first network One of the outputs of the second, auto-associative network is a set of learning parameters (i.e., learning rate and momentum) for the first, hetero-associative network. The second network also calculates a delta value. In one mode, this delta value represents the difference between a supplied training output pattern and an actual output pattern generated by the second network in response to a supplied training input pattern. In one version of this embodiment, the delta value is proportional to a Euclidian distance between the supplied training output pattern and the actual output pattern. The delta value calculated by the second network represents a novelty metric that is further utilized by the system. In this mode, the delta value or novelty metric is used to adjust the learning parameters for the first network. This is generally referred to as the novelty mode of the system in which the strength of learning reinforcement for the first network is determined by the second network. This mode is diagrammatically illustrated in FIG. 10.

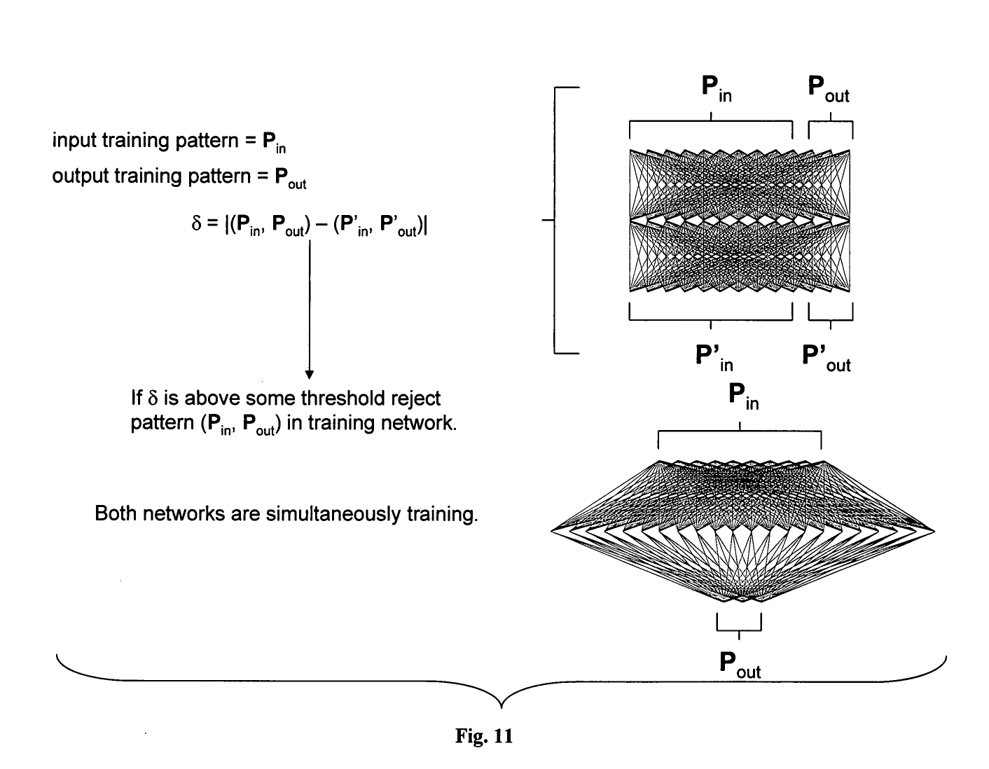

In a second mode of the above embodiment, the “input” patterns supplied to the second network consist of pairs of inputs and corresponding outputs (Pᵢₙ, Pₒᵤₜ). In response, the second network generates a pair of inputs and outputs (P′ᵢₙ, P′ₒᵤₜ). In this case, the delta value (δ) is representative of the difference between (Pᵢₙ, Pₒᵤₜ) and (P′ᵢₙ, P′ₒᵤₜ). In one version, the delta value is calculated as the absolute value of (Pᵢₙ, Pₒᵤₜ)−(P′ᵢₙ, P′ₒᵤₜ) In another version, the delta value is proportional to the Euclidian distance between (Pᵢₙ, Pₒᵤₜ) and (P′ᵢₙ, P′ₒᵤₜ). The delta value is compared to a specified novelty threshold. If the delta value for a particular pair of inputs and outputs (Pᵢₙ, Pₒᵤₜ) exceeds the novelty threshold, then that training pair is rejected and excluded from further use to train the first network. This mode is diagrammatically illustrated in FIG. 11. U.S. Pat. Nos. 6,014,653 and 5,852,816, the disclosures of which are expressly incorporated herein by reference, provide additional explanation of the use of novelty detection via auto-associative nets to adjust learning rate or reject exemplars.

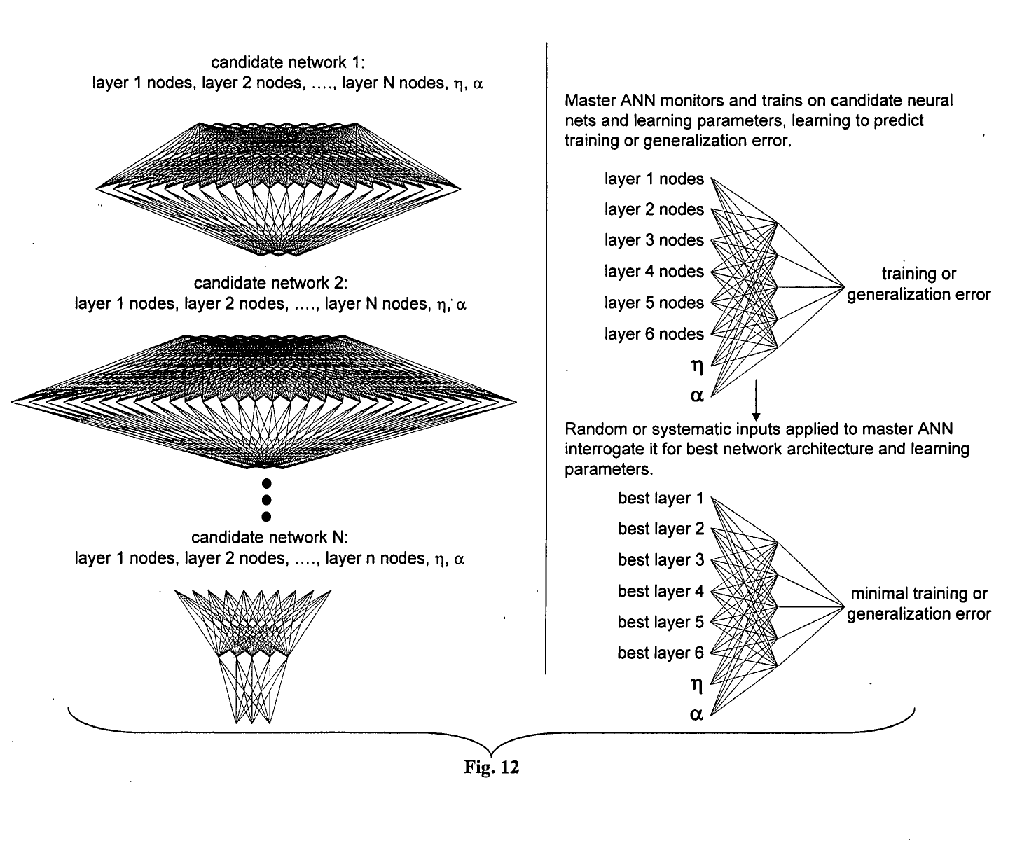

In another embodiment, the system operates largely independently to determine an optimal architecture and set of learning parameters for a given set of training data. The system automatically generates a series of trial networks, each provided with random hidden layer architectures and learning parameters. As each of these candidate networks trains on the provided data, their training or generalization error is calculated using training data or set aside data, respectively. Yet another network, a master network, then trains on a set of data that consists of the variations in architecture and learning parameters used in the trial networks and the resulting learning or generalization errors of those networks. This data may be delivered directly to the master network as it is “developed” by the trial networks or it may be stored in memory as a set of input and output patterns and introduced to or accessed by the master network after training of the trial networks is completed. Following training of the master network, the master network is stochastically interrogated to find that input pattern (i.e., the combination of hidden layer architectures and learning parameters) that produces a minimal training or generalization error at its output. This process is diagrammatically illustrated in FIG. 12. Another example of a target seeking algorithm U.S. Pat. No. 6,115,701, the full disclosure of which is hereby expressly incorporated by reference herein.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

What is claimed is:

1. A neural network trainer, comprising a user-determined set of scripted training instructions and parameters for training an untrained artificial neural network, said set of scripted training instructions and parameters specified by a scripting language.

2. The neural network trainer of claim 1, wherein said scripting language is an Extended Markup Language.

3. The neural network trainer of claim 1, further comprising a training wizard operable for generating said set of scripted training instructions and parameters.

4. An artificial neural network-based data analysis system, comprising:
an artificial neural network, said neural network comprising a first layer and at least one subsequent layer, each said layer further comprising at least one neuron;
each said neuron in any of said layers being connected with at least one of said neurons in any subsequent layer, each said connection being associated with a weight value; and
a three-dimensional representation of said artificial neural network.

5. The neural network trainer of claim 4, further comprising a display mode having a two-dimensional interpretation of said three-dimensional representation of said artificial neural network wherein said two-dimensional interpretation of said artificial neural network is manipulable to be viewed from a plurality of vantage points.

6. The neural network trainer of claim 4, wherein
said connection between each neuron in said first layer and said neuron in said subsequent layer can be isolated to determine a magnitude of said weight value associated with said connection.

7. The neural network trainer of claim 4, wherein:
said three-dimensional representation of said artificial neural network further comprising representative nodes corresponding to each said neuron; and
wherein each said neuron can be isolated for analysis by selecting said corresponding representative node within said three-dimensional representation of said artificial neural network.

8. The neural network trainer of claim 6, further comprising means for selectively removing any of said connections based on said magnitude of said weight value associated with each said connection.

9. The neural network trainer of claim 8, wherein said means for selectively removing connections removes connections having lower relative magnitude weight values before removing connections having higher relative magnitude weight values.

10. The neural network trainer of claim 8, wherein said means for selectively removing connections comprises a slider.

11. The neural network trainer of claim 9, wherein said three-dimensional representation of said artificial neural network comprises:
a representative node corresponding to each said neuron; and
a representative line corresponding to each said connection; and
wherein said representative lines corresponding to said removed connections are deleted from said three-dimensional representation of said artificial neural network.

12. The neural network trainer of claim 4, wherein said three-dimensional representation of said artificial neural network comprises:
a representative node corresponding to each said neuron; and
a representative line corresponding to each said connections; and
wherein each said representative line is color-coded based on a magnitude and an algebraic sign of said weight value associated with said corresponding connection.

13. The neural network trainer of claim 12, wherein each said representative line is coded with a first color if said corresponding connection is associated with a positive weight and is coded with a second color if said corresponding connection is associated with a negative weight.

14. A neural network trainer, comprising:
an artificial neural network comprising a first layer and at least one subsequent layer, each said layer further comprising at least one neuron; and
means for isolating each said first layer neuron and modifying an input value to said first layer neuron directly to observe associated changes at one of said subsequent layers.

15. The neural network trainer of claim 14, wherein said means for modifying said input values to each said first layer neuron is a slider.

16. The neural network trainer of claim 14, wherein said input values may be modified during training of the artificial neural network.

17. The neural network trainer of claim 14, wherein said input values may be modified after training of the artificial neural network.

18. The neural network trainer of claim 1, wherein said artificial neural network comprises a first layer and at least one subsequent layer, each said layer further comprising at least one neuron;
each said neuron in any of said layers being connected with at least one of said neurons in any subsequent layer, each said connection being associated with a weight value; and
further comprising a first program function operative to translate said connection weights of said trained artificial neural network into an artificial neural network expressed in a programming language.

19. The neural network trainer of claim 18, wherein said programming language is selected from the group consisting of: C, C++, Java™, Microsoft® Visual Basic®, VBA, ASP, Javascript™, Fortran, MATLAB files, and software modules for a hardware target.

20. A neural network trainer, comprising
an untrained artificial neural network;
a set of training instructions and parameters for training said untrained artificial neural network; and
a program function operative to convert said trained artificial neural network into a spreadsheet format.

21. The neural network trainer of claim 20, wherein said second program function transfers said trained artificial neural network into a spreadsheet program by translating said trained neural network to a scripting language and transferring said translated artificial neural network to a macro space associated with said spreadsheet.

22. The neural network trainer of claim 20, wherein said second program transfers said trained artificial neural network into a spreadsheet program by translating said trained artificial neural network into a series of interconnected cells within said spreadsheet program.

23. The neural network trainer of claim 1, further comprising a set of input patterns and a third program function operative to input said set of input patterns to said trained artificial neural network in a batch mode.

24. An artificial neural network-based data analysis system, comprising:
an untrained, artificial neural network comprising at least a first layer and at least one subsequent layer, each said layer further comprising at least one neuron and each said neuron in any of said layers being connected with at least one of said neurons in any subsequent layer, said artificial neural network being operative to produce at least one output pattern when at least one input pattern is supplied to said first artificial neural network; and
a user-determined set of scripted training instructions and parameters for training said first artificial neural network, said set of training instructions and parameters specified by a scripting language.

25. The system of claim 24, wherein said scripting language is an Extended Markup Language.

26. The system of claim 24, further comprising a training wizard operable for generating said set of scripted training instructions and parameters.

27. The system of claim 24, further comprising a three dimensional representation of said artificial neural network.

28. The system of claim 27, further comprising a display mode wherein said three dimensional representation of said artificial neural network is manipulable to be viewed from a plurality of vantage points.

29. The system of claim 27, wherein:
each said connection having a weight value; and
said connection between each said neurons can be isolated to determine a magnitude and an algebraic sign of said weight value.

30. The system of claim 29, further comprising means for selectively removing any of said connections based on said magnitude of said weight value associated with said connection.

31. The system of claim 30, wherein said means for selectively removing connections removes connections having lower relative magnitude weight values before removing connections having higher relative magnitude weight values.

32. The system of claim 30, wherein said means for selectively removing connections comprises a slider.

33. The system of claim 30, wherein said three-dimensional representation of said artificial neural network comprises:
a representative node corresponding to each said neuron;
a representative line corresponding to each said connection; and
wherein said representative lines corresponding to said removed connections are deleted from said three-dimensional representation of said artificial neural network.

34. The system of claim 30, wherein said three-dimensional representation of said artificial neural network comprises:
a representative node corresponding to each said neuron;
a representative line corresponding to each said connection; and
wherein each said representative line is color-coded based on said weight value associated with said corresponding connection.

35. The system of claim 34, wherein each said representative line is coded with a first color if said corresponding connection is associated with a weight value having a positive algebraic sign and is coded with a second color if said corresponding connection is associated with a weight value having a negative algebraic sign.

36. The system of claim 24, further comprising means for isolating and varying each first layer neuron and modifying an input value to said first layer neuron directly to observe associated changes at any subsequent layer.

37. The system of claim 36, wherein said means for isolating and varying input values to each first layer neuron is a slider.

38. The system of claim 36, wherein said input values are modifiable during training of said artificial neural network.

39. The system of claim 36, wherein said input values are modifiable after training of said artificial neural network.

40. The system of claim 24, further comprising a first program function operative to translate said connection weight values of said trained artificial neural network into an artificial neural network module expressed in a computer language.

41. The system of claim 24, wherein said programming language is selected from the group consisting of: C, C++, Java™, Microsoft® Visual Basic®, VBA, ASP, Javascript™, Fortran, MATLAB files, and software modules for a hardware target.

42. The system of claim 24, further comprising a second program function operative to convert said trained artificial neural network into a spreadsheet format.

43. The neural network trainer of claim 42, wherein said second program function transfers said trained artificial neural network into a spreadsheet program by translating said trained neural network to a scripting language and transferring said translated artificial neural network to a macro space associated with said spreadsheet.

44. The system of claim 42, wherein said second program transfers said trained artificial neural network into a spreadsheet program by translating said trained artificial neural network into a series of interconnected cells within said spreadsheet program.

45. The system of claim 24, further comprising a third program function operative to input said set of input patterns to said trained artificial neural network in a batch mode.

46. The system of claim 24, further comprising at least one previously trained artificial neural network and a memory and wherein said previously trained artificial neural network is stored in said memory and is available for importation into and use within said system.

47. An artificial neural network-based data analysis system, comprising:
a system algorithm being operative for constructing a proposed, untrained, artificial neural network;
at least one training file comprising at least one pair of a training input pattern and a corresponding training output pattern and a representation of said training file; and
wherein construction and training of said untrained artificial neural network is initiated by selecting said representation of said training file.

48. A neural network trainer, comprising:
at least a first pair of a training input pattern and a corresponding training output pattern;
a first, untrained, artificial neural network;
a second, auto-associative artificial neural network, said second artificial neural network being operative to produce a delta value and to calculate a learning rate associated with said first artificial neural network; and
wherein said delta value represents a novelty metric.

49. The system of claim 48, wherein said second, auto-associative artificial neural network is operative to produce an actual output pattern when said training input pattern is supplied to said second neural network;
wherein said delta value is proportional to a difference between said training output pattern and said actual output pattern; and
wherein said novelty metric is associated with said training input pattern and wherein said learning rate for said first artificial neural network is adjusted in proportion to said novelty metric.

50. The system of claim 48, further comprising at least a first combined input pattern including a second training input and a corresponding, second training output;
wherein said second, auto-associative artificial neural network is operative to produce an actual combined output when said combined input pattern is supplied to said second neural network, said actual combined output comprising an actual input and a corresponding actual output;
wherein said delta value is proportional to a difference between said combined input pattern and said actual combined output; and
wherein said novelty metric is associated with said actual combined output and wherein said learning rate for said first artificial neural network is adjusted in proportion to said novelty metric.

51. The system of claim 48,
further comprising a specified novelty threshold; and
wherein said second artificial neural network rejects said pair if said novelty metric exceeds said specified novelty threshold.

52. The system of claim 48, wherein said second artificial neural network is training with said first artificial neural network.

53. An artificial neural network-based data analysis system, comprising:
at least a first pair of a training input and a corresponding training output;
a first, untrained, artificial neural network being operative to produce at least one output when at least one input is supplied to said first artificial neural network; and
a comparator portion, said comparator portion being operative to compare an actual output pattern generated by said first artificial neural network as result of said training input pattern being supplied to said first artificial neural network with said corresponding training output, said comparator portion being further operative to produce an output error based on said comparison of said actual output with said corresponding training output and being operative to determine a learning rate and a momentum associated with said first artificial neural network; and
wherein said learning rate and momentum for said first artificial neural network are adjusted in proportion to said output error.

54. The system of claim 53, wherein said comparator portion comprises a second auto-associative artificial neural network, said second artificial neural network training with said first artificial neural network.

55. An artificial neural network-based data analysis system, comprising:
at least a first pair of a training input pattern and a corresponding training output pattern;
a first, untrained, artificial neural network; and
a first algorithm associated with said system and being operative to generate an architecture, learning rate, and a momentum for said first artificial neural network randomly or systematically;
at least a second, untrained artificial neural network, said second neural network being trained simultaneously with or sequentially after said first artificial neural network;
a second architecture, learning rate, and second momentum associated with said second artificial neural network, said architecture, learning rate, and momentum generated randomly or systematically by said first algorithm;
a comparator algorithm being operative to compare an actual output pattern generated by either of said artificial neural networks as a result of said training input pattern being supplied to either said artificial neural network with said corresponding training output pattern, said comparator algorithm being further operative to produce an output error based on a calculation of a cumulative learning error;
a third artificial neural network being operative to receive and train on said architectures, learning rates, momentums, and learning errors associated with said first and second artificial neural networks; and
means for varying inputs to said third artificial neural network to observe associated outputs of said third artificial neural network to identify an optimal network architecture and an optimal set of learning parameters.
